(19) United States
(12) Patent Application Publication
(10) Pub. No.: US 2016/0194039 A1
(43) Pub. Date: Jul. 7, 2016

(54) LINK ASSEMBLY FOR A TRACK

(71) Applicant: Caterpillar Inc., Peoria, IL (US)

(72) Inventors: David Patrick Fitzgibbons, JR., Metamora, IL (US); Timothy Arthur Thorson, Morton, IL (US); Cedric Hervé Tabone, Jarrie (FR); Jeff Alan Jensen, Dunlap, IL (US); Douglas Trent Weaver, Peoria Heights, IL (US)

(73) Assignee: Caterpillar Inc., Peoria, IL (US)

(21) Appl. No.: 15/067,206

(22) Filed: Mar. 11, 2016

(51) Int. Cl. B62D 55/20; B62D 55/21

(52) U.S. Cl. CPC B62D 55/20; B62D 55/21

(57) ABSTRACT

A link assembly for a track comprises a first side plate, and a second side plate coupled with the first side plate such that proximal surfaces of the first and second side plates are disposed in abutment with one another. The link assembly further includes a wear plate assembly that is coupled to a top face of the first side plate and a top face of the second side plate. The wear plate assembly is formed from a material having a wear resistance greater than a wear resistance of the first and second side plates.

### TECHNICAL FIELD

The present disclosure generally relates to mobile machines using tracks. In particular, the present disclosure relates to a link assembly for a track of the mobile machine.

### BACKGROUND

Mobile machines such as for e. g., tractors, excavators, and crawlers typically include endless rotary track chains that assist in movement of the machine. Links that form part of such track chains may be subject to harsh working environments and hence, formed to exhibit adequate strength in withstanding the high operational forces typically encountered in such working conditions. However, using wear-resistant materials to form an entire mass of each link in the track chain could significantly increase material costs while also increasing costs associated with manufacture of the links.

In some cases, links of the track chain have been typically known to undergo a forging and heat treatment process prior to implementation and use in a track chain. Although the links may be forged and heat treated to protect against wear, they may not be cost effective due to the high production costs and long cycle times associated with the forging and heat treatment process itself.

U.S. Pat. No. 8,905,493 (hereinafter referred to as the '493 reference) discloses a composite track link assembly for a track-type machine. The track link includes a body and a replaceable rail. The body and the rail may be formed of different materials. The rail is brazed or soldered to provide a metallurgical bond between a top surface of the track link and the rail. When the rail is worn-out, the rail may be removed and replaced by heating the brazing or soldering filler metal. This process enables the rail to be separated from the top surface of track link, so that a new rail can be brazed or soldered to the top surface of track link. This way, track links or bodies of track links may outlast the rails by multiple cycles.

Although the '493 reference discloses that the replaceable rail and the link body may have different material properties, the link body appears to be a unitary piece. Such a configuration of the link body may not provide flexibility to the manufacturers in using the link body for forming a master link of the track chain.

Hence, there is a need for a link assembly that is wear-resistant yet cost-effective to produce. Further, there is a need for a link assembly that can allow manufacturers to conveniently use such link assembly in forming a master link of a track chain.

### SUMMARY OF THE DISCLOSURE

In an aspect of the present disclosure, a link assembly for a track comprises a first side plate, and a second side plate coupled with the first side plate such that proximal surfaces of the first and second side plates are disposed in abutment with one another. The link assembly further includes a wear plate assembly that is coupled to a top face of the first side plate and a top face of the second side plate. The wear plate assembly is formed from a material having a wear resistance greater than a wear resistance of the first and second side plates.

Other features and aspects of this disclosure will be apparent from the following description and the accompanying drawings.

### BRIEF DESCRIPTION OF THE DRAWINGS

FIG. 1 is a diagrammatic view of an exemplary machine, in which embodiments of the present disclosure can be implemented;

FIG. 2 is an exploded view of a link assembly that can be implemented in tracks of the mobile machine of FIG. 1, in accordance with an embodiment of the present disclosure;

FIG. 3 is an assembled view of the link assembly from FIG. 2, in accordance with an embodiment of the present disclosure;

FIG. 4 is an exploded view of a link assembly that can be implemented in tracks of the mobile machine of FIG. 1, the link assembly showing bolt holes in accordance with another embodiment of the present disclosure; and

FIG. 5 is an assembled view of the link assembly of FIG. 4, in accordance with another embodiment of the present disclosure.

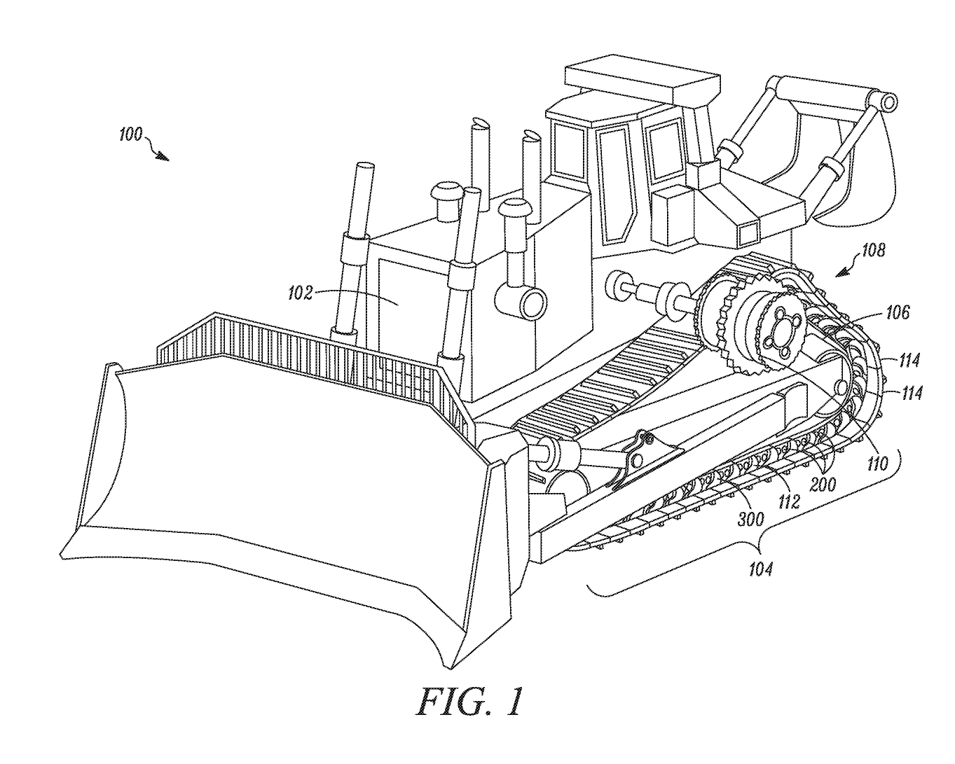

### DETAILED DESCRIPTION

Wherever possible, the same reference numbers will be used throughout the drawings to refer to the same or the like parts. FIG. 1 illustrates an exemplary machine 100. The machine 100 may embody a mobile machine that performs some type of operation associated with an industry such as mining, construction, farming, transportation, or any other industry known in the art. For example, the machine 100 may be an earth moving machine such as an excavator, a dozer, a loader, a backhoe, a motor grader, or any other earth moving machine. The machine 100 may include a power source 102 and an undercarriage assembly 104. The undercarriage assembly 104 may be configured to be driven by power source 102 and supported by one or more spaced-apart pulley mechanisms 106.

The power source 102 may drive the undercarriage assembly 104 at a range of output speeds and torques. In an embodiment, the power source 102 may be an engine. The engine may be configured to combust a fuel to release the chemical energy therein and convert that energy to mechanical power. The engine may be a compression ignition engine that combusts diesel fuel. Alternatively, the engine may include a spark ignition engine that is configured to combust gasoline or other fuels such as ethanol, bio-fuel, natural gas and so on In another embodiment, the power source 102 may also be a non-combustion source of power such as, for example, a fuel cell, a power storage device, or any other source of power known in the art.

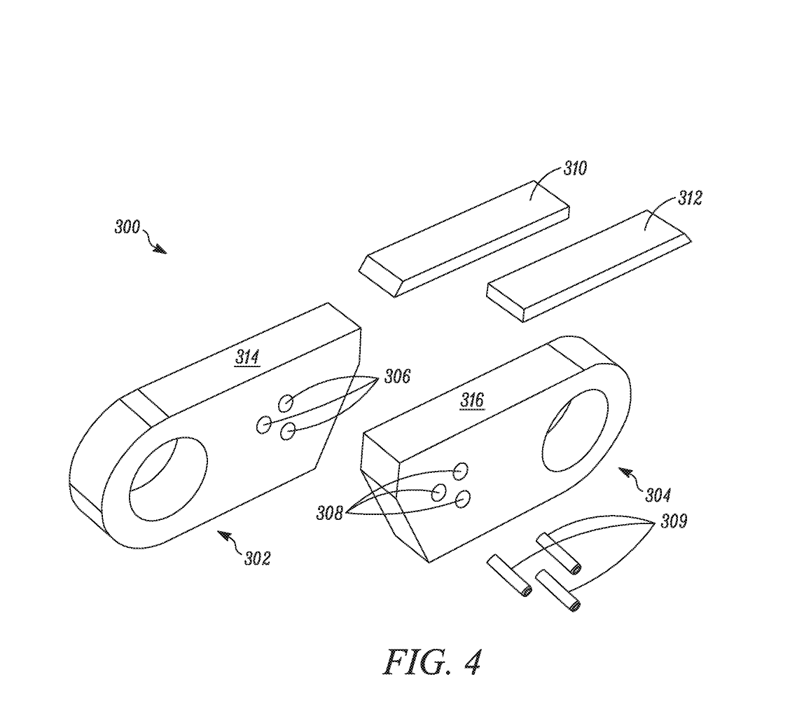

The undercarriage assembly 104 may include two separate continuous tracks 108, one on either side of the machine 100 (only one of which is shown in FIG. 4 Each track 108 may be driven by power source 102 via one or more sprockets 110. In addition, each of the track 108 may include a chain 112 and a plurality of track shoes 114, each configured to selectively engage a surface, e.g., the ground. Each chain 112 may include a plurality of link assemblies 200.

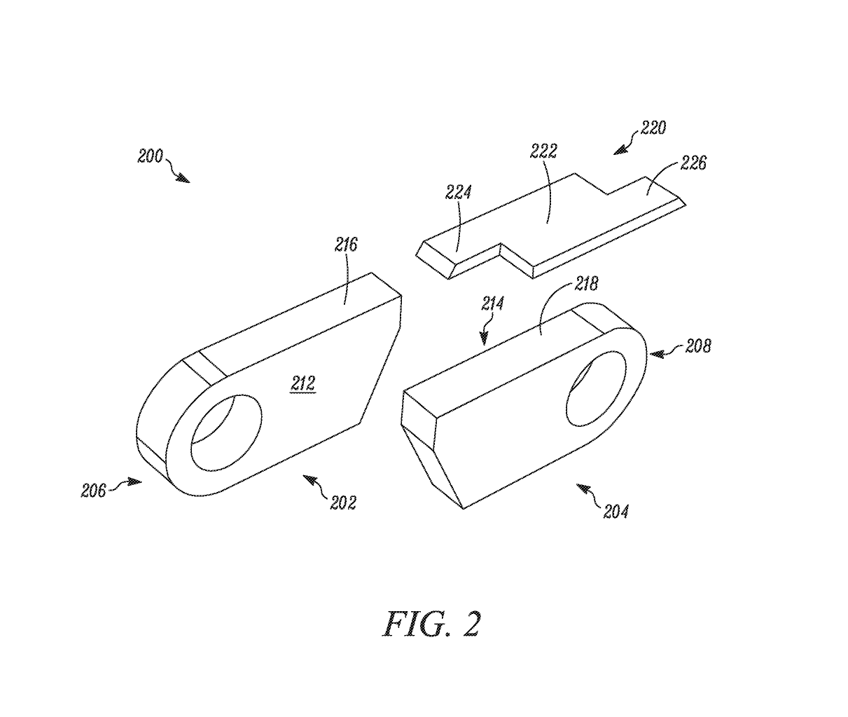

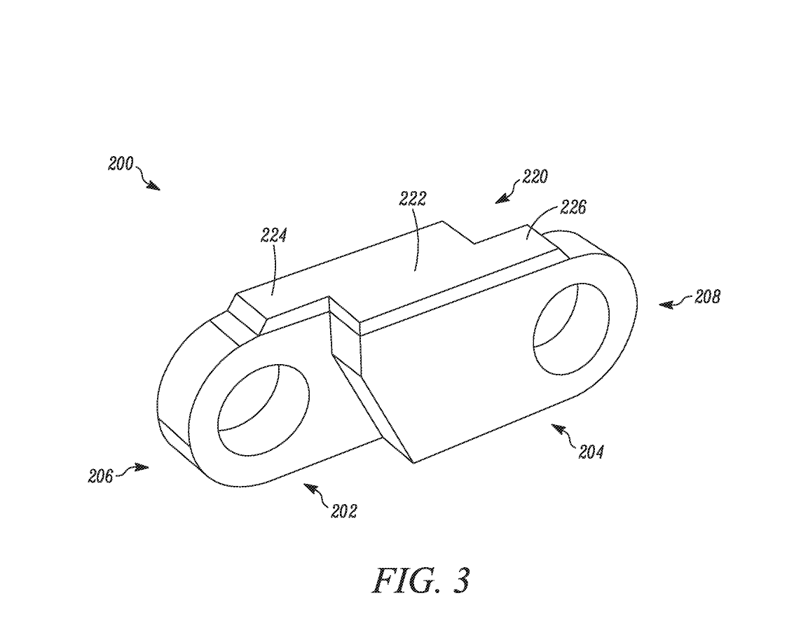

Each of the link assemblies 200 are coupled to the track shoe 114 using fasteners e.g., a bolt or a screw. Further, the link assemblies 200 are coupled to each other to form a continuous configuration for the tracks 108. Specifically, a number of the link assemblies 200 are mechanically coupled to the adjacent link assemblies 200 so that when an appropriate number of these link assemblies 200 are connected together, the chain 112 is formed. The chain 112 may have a predetermined length for a given application with opposite ends that are capable of being connected together to form a closed loop. In an example, adjacent ones of link assemblies 200 may be interconnected by way of rod members (not shown). The sprockets 110 may engage and transmit a torque to rods to thereby cycle the chain 112 about the spaced apart pulley mechanisms 106. The representative link assembly 200 will be explained hereinafter with reference to FIGS. 2 and 3.

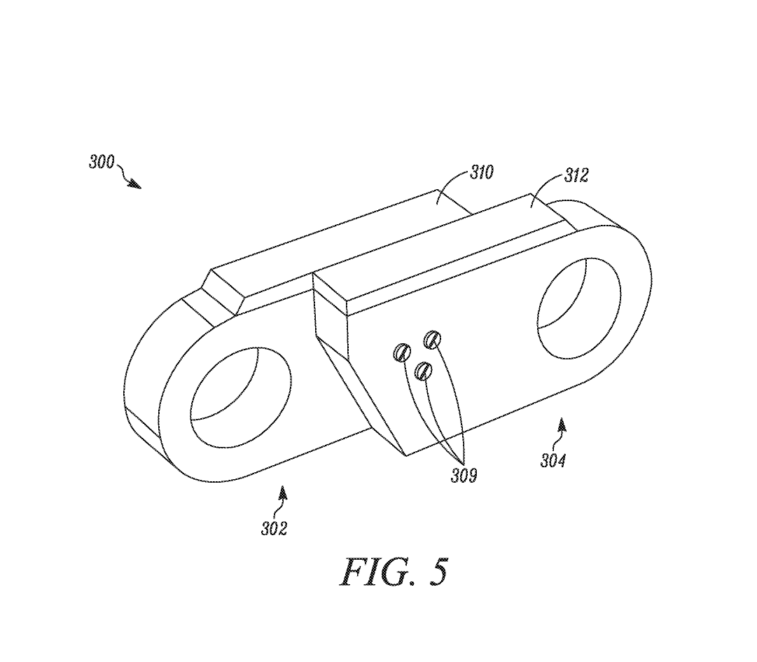

At least one link assembly 300 among the plurality of link assemblies 200 of the track 108 is configured to be a master link assembly 300. The master link assembly 300 may be interconnected between the two link assemblies 200 by way of rod members. The master link assembly 300 is configured to allow disassembly of the chain 112 to two separate ends. The master link assembly 300 will be explained in detail later with reference to FIGS. 4 and 5.

Referring now to FIGS. 2 and 3, the link assembly 200 according to one embodiment of the present disclosure is illustrated. As shown, the link assembly 200 includes a first side plate 202 and a second side plate 204 that is configured to be coupled to the first side plate 202. The first and second side plates 202, 204 have a substantially similar configuration. The first side plate 202 may have a planar configuration with one end 206 having an arcuate shape. Similarly, the second side plate 204 may have a planar configuration with one end 208 having an arcuate shape. Each of the first side plate 202 and the second side plate 204 defines a hole 210 adjacent to the respective ends 206, 208. Various link assemblies 200 of the track 108 may be coupled to each other using fasteners inserted in the respective holes 210.

Moreover, the first and second side plates 202, 204 are disposed such that the ends 206, 208 are distally located from one another. Further, the second side plate 204 is coupled with the first side plate 202 such that proximal surfaces 212, 214 of the first and second side plates 202, 204 respectively, are disposed in abutment with one another. As such, a top face 216 of the first side plate 202 and a top face 218 of the second side plate 204 together form an overlapping region.

In an embodiment, the first and second side plates 202, 204 may be coupled to each other by a welding process. In an example, a linear friction welding may be used to couple the first and second side plates 202, 204. In another embodiment, the first and second side plates 202, 204 may be mechanically coupled to each other using bolts, pins and the like. However, it may be contemplated to use other suitable methods to accomplish the coupling between the first and second side plates 202, 204.

In another embodiment, the first side plates and the second side plates 202 and 204 are manufactured as a unitary component through a molding process.

In an embodiment, the first and second side plates 202, 204 may be chosen to have a hardness greater than or equal to 28 Rkw C-40 Rkw C. In an example, the first and second side plates 202, 204 may be made of 35RC steel. Other materials may also be contemplated for use in forming the first and second side plates 202, 204. The first and second side plates 202, 204 may be manufactured using any suitable process such as, fabrication, machining, casting, forging. For example, a pre-hardened material may be taken and machined to a required shape to form the first and second side plates 202, 204.

The link assembly 200 further includes a wear plate assembly. In an embodiment, the wear plate assembly includes a unitary wear plate 220 corresponding to the top surfaces 216, 218 of the first and second side plates 202, 204. The wear plate 220 may be provided to protect the top faces 216, 218 of the first and second side plates 202, 204 that are more prone to wear. In the embodiment of FIG. 2, the wear plate 220 has a z shape having a central portion 222 and two longitudinal portions 224, 226 extending therefrom. The wear plate 220 is coupled to the top face 216 of the first side plate 202 and the top face 218 of the second side plate 204. More specifically, the central portion 222 may be coupled to the overlapping region of the side plates 202, 204 and the longitudinal portions 224, may be disposed on the respective top faces 216, 218.

In an embodiment, the wear plate 220 may be coupled to the first and second side plates 202, 204 by a welding process. In a preferred embodiment, the wear plate 220 may be coupled to the first and second side plate 202, 204 using a linear friction welding process. In another embodiment, the wear plate 220 may be coupled to the first and second side plates 202, 204 by mechanical fixtures. However, it may be contemplated to use various other methods to accomplish the coupling of the wear plate 220 with the first and second side plates 202 204.

Further, the wear plate 220 is formed from a material having a wear resistance greater than a wear resistance of the first and second side plates. Such wear resistance may be obtained by suitably hardening or strengthening the wear plate 220. In an embodiment, the wear plate 220 may be strengthened using suitable heat treatment methods. Moreover, the wear plate 220 may have a hardness greater than or equal to 50 Rkw C. In an example, the wear plate 220 may be made from 65RC steel material. In other examples, the wear plate 220 may be made by other materials so as to obtain a wear resistance greater than the wear resistance of each of the first and second side plates 202, 204.

Referring to FIGS. 4 and 5, a link assembly 300 according to another embodiment of the present disclosure is illustrated. As shown, the link assembly 300 is the master link assembly 300 that is configured to allow disassembly of the chain 112 of the track 108. Accordingly, the master link assembly 300 includes a first side plate 302 and a second side plate 304 configured to removably coupled to the first side plate 302.

In the illustrated embodiment, the first side plate defines one or more apertures 306 therein. Similarly, the second side plate 304 defines corresponding apertures 308 therein. The apertures 306, 308 of the first and second side plates 302, 304 are configured to be disposed in mutual alignment with one another. Further, the apertures 306, 308 are configured to receive a retaining member 309 therethrough. In the illustrated embodiment, the retaining member 309 is a dowel pin. In other embodiments, the retaining member 309 may embody other mechanical fasteners such as, but not limited to, a bolt, a rivet and a screw.

In the illustrated embodiment of the link assembly 300, the wear plate assembly includes two wear plates 310, 312. The wear plates 310, 312 are configured to be coupled to a top face 314 of the first side plate 302 and a top face 316 of the second side plate 304 respectively. In an embodiment, the wear plates 310, 312 may be coupled to the respective first and second side plates 302, 304 using a welding process. In a preferred embodiment, the wear plates 310, 312 may be coupled using a friction welding process.

Similar to the link assemblies 200, as described above, the wear plates 310, 312 may have a wear resistance greater than the wear resistance of each of the first and second side plates 302, 304. In an example, the first and second side plates 302, 304 may be made of low cost steel material. Further, the wear plates 310, 312 may be made of high hardness and wear material. Although, two wear plates 310, 312 are illustrated, it may be envisioned to provide multiple wear plates coupled to the top faces 314, 316. In such a case, optionally different materials may be used for each of these wear plates based on the wear resistance requirements.

In an alternative embodiment, the first side plate 302 and the corresponding wear plate 310 may be manufactured as an integral component to have a unitary construction. Similarly, the second side plate 304 and the wear plate 312 may be manufactured as an integral component to have a unitary construction. In such a case, the wear plates portion 310, 312 of the master link assembly 300 may be selectively hardened to provide the required wear resistance.

### INDUSTRIAL APPLICABILITY

The present disclosure is related to various embodiments of the link assemblies 200, 300. For example, the link assembly 200 is formed using multiple separate parts such as two side plates 202, 204 and the wear plate 220. The link assembly 200, 300 may be manufactured and assembled using a simple and easy process. For example, various parts of the link assembly 200, 300 may be machined to the required shape and then assembled using simple mechanical fasteners and/or using efficient welding process such as friction welding. As such, the link assembly 200, 300 of the present disclosure presents a cost-effective solution compared to the conventional link assemblies which is manufactured as a unitary component using a forging process.

Additionally, such a configuration of using separate parts enables selecting different materials for each of these parts. Moreover, if a fracture or a crack occurs in one of the part, such part may be replaced and used with the existing link assembly unlike the conventional integral link where, there is a possibility of crack propagation to the entire component.

Further, the substantial wear and tear occurs on the top faces of the first and second side plates. As such, there is no necessity for providing high wear resistance to the entire link assembly. The link assembly 200 of the present disclosure includes the wear plate 220 that is coupled to the top faces 216, 218 of the first and second side plates 202, 204. Moreover, only the wear plate 220 is provided with the wear resistance that is greater than the wear resistance of the first and second side plates 202, 204. Such an implementation decreases the cost by avoiding usage of high strength materials and/or performing hardening process for the entire link assembly.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A link assembly for a track of a mobile machine, the link assembly comprising:
a first side plate;
a second side plate coupled with the first side plate such that proximal surfaces of the first and second side plates are disposed in abutment with one another; and
a wear plate assembly coupled to a top face of the first side plate and a top face of the second side plate, the wear plate assembly formed from a material having a wear resistance greater than a wear resistance of the first and second side plates.

2. The link assembly of claim 1, wherein the wear plate assembly includes a unitary wear plate corresponding to the top surfaces of the first and second side plates.

3. The link assembly of claim 1, wherein proximal surfaces of the first and second side plates are welded to one another.

4. The link assembly of claim 1, wherein the first side plate and the second side plate are manufactured as a unitary component.

5. The link assembly of claim 1, wherein the wear plate assembly is welded to the top surfaces of the first and second side plates.

6. The link assembly of claim 1, wherein the wear plate assembly includes a pair of wear plates corresponding to the top surfaces of the first and second side plates.

7. The link assembly of claim 1, wherein each of the first side plate and the second side plate define at least one aperture therein, the apertures of the first and second side plates adapted to be disposed in mutual alignment with one another for receiving at least one retaining member therethrough.

8. The link assembly of claim 7, wherein the at least one retaining member is one of: a bolt, a rivet, and a dowel pin.
